(19) United States
(12) Patent Application Publication
(10) Pub. No.: US 2025/0100089 A1
(43) Pub. Date: Mar. 27, 2025

(54) MULTI-BEAM ASYNCHRONOUS PRECISION LASER CUTTING MACHINE

(71) Applicant: Taicang Manaflex Technology Co., Ltd., Taicang City (CN)

(72) Inventor: Fujiang LI, Kunshan City (CN)

(21) Appl. No.: 18/883,148

(22) Filed: Sep. 12, 2024

(30) Foreign Application Priority Data
Sep. 15, 2023 (CN) 202322519278.7

(51) Int. Cl. B23K 37/02; B23K 26/08; B23K 26/38; B23K 37/00

(52) U.S. Cl. CPC B23K 37/0211; B23K 26/0869; B23K 26/38; B23K 37/006

(57) ABSTRACT

A multi-beam asynchronous precision laser cutting machine includes a horizontally arranged bed body, longitudinal beams and several gantry cutting mechanisms, which include cross beams, lifting mechanisms and laser optical cutting head, the tops of the two longitudinal beams have first guide rails, and the top of one of the longitudinal beams has a first linear motor, and connecting seats are at the bottoms of both ends of the cross beam, and connecting seats connect the first guide rail slider and the first linear motor mover assembly, a second guide rail, the cross beam top has a second linear motor, and the lifting mechanism is connected through a first slide block connected to the second guide rail and the second linear motor mover assembly, the lifting mechanism includes a servo motor machine and a second sliding seat, and the laser cutting head is fixed on the second sliding seat.

### CROSS-REFERENCE TO RELATED APPLICATION

This application claims priority to and the benefit of Chinese Utility Model application No. 202322519278.7, filed Sep. 15, 2023, the entire disclosure of which is incorporated by reference in its entirety.

### TECHNICAL FIELD

This disclosure relates to the field of coil processing technology, and in particular to a multi-beam asynchronous precision laser cutting machine.

### BACKGROUND TECHNOLOGY

Due to its low cost and other reasons, metal aluminum is gradually replacing metal copper and is used as a conductor in vehicle-mounted flexible printed circuits (FPCs) or in power management system CCS (cells contact system), integrated busbar and/or busbar, etc. of a power battery, such as, an automotive power battery. In a CCS management system, aluminum foil with a thickness of less than 0.25 mm is cut by a laser galvanometer, while aluminum foil with a thickness of more than 0.25 mm needs to be cut by a laser cutting head. The gantry structure of the cutting machine drives the laser cutting head to move and complete the cutting. Although the cutting head plus gantry method can cut thicker aluminum foil, its efficiency is much lower than that of the galvanometer cutting, and this cutting machine cannot meet the efficiency requirements of online production. Therefore, improvements are needed.

### SUMMARY

The purpose of the techniques disclosed herein is to provide a multi-beam asynchronous precision laser cutting machine to overcome the shortcomings of the existing technology.

To achieve the above-mentioned purpose, the techniques disclosed herein provide the following technical solutions:
The present disclosure relates to a multi-beam asynchronous precision laser cutting machine, which includes a horizontally arranged bed, longitudinal beams arranged on both sides of the top of the bed, and a plurality of gantry cutting mechanisms sliding on the longitudinal beams. The gantry cutting mechanism comprises a transverse beam perpendicular to the longitudinal beam, a lifting mechanism slidingly arranged on the transverse beam, and a connecting link. A laser cutting head connected to the lifting mechanism, and the tops of the two longitudinal beams are respectively provided with a first guide rail along their length direction, and the top of one longitudinal beam is provided with a first linear motor parallel to the first guide rail. The bottoms of the two ends of the transverse beam are respectively provided with a connecting seat, and the connecting seat is connected to the slider of the first guide rail and the moving subassembly of the first linear motor. The side of the transverse beam is provided with a second guide rail along its length direction, and the top of the transverse beam is provided with a second linear motor. The lifting mechanism is connected to the slider of the second guide rail and the moving subassembly of the second linear motor through the first slide seat. The lifting mechanism comprises a fixed slider fixed to the top of the first slide seat.

The servo motor at the end and the second slide connected to the servo motor are driven, and the laser cutting head is fixed to the second slide.

Further, in the above-mentioned multi-beam asynchronous precision laser cutting machine, the bed is integrally formed of granite, and its top surface is provided with avoidance grooves corresponding to the laser cutting head, and the thickness of the bed is greater than 250 mm.

Further, in the above-mentioned multi-beam asynchronous precision laser cutting machine, the beam is integrally formed of aluminum alloy. It is formed in one piece and a plurality of weight-reducing holes are provided inside.

Further, in the above-mentioned multi-beam asynchronous precision laser cutting machine, the cross section of the weight-reducing hole is triangular.

Further, in the above-mentioned multi-beam asynchronous precision laser cutting machine, the first linear motor and the second linear motor are both bilateral linear motors.

Further, in the above-mentioned multi-beam asynchronous precision laser cutting machine, an anti-collision device is provided between adjacent beams.

Further, in the above-mentioned multi-beam asynchronous precision laser cutting machine, the anti-collision device includes a limit sensor, a buffer device and a grating ruler for monitoring and measuring position.

Furthermore, in the above-mentioned multi-beam asynchronous precision laser cutting machine, the longitudinal beam and the cross beam are respectively provided with accordion protective covers.

Compared with the prior art, the advantages of the present disclosure are: the multi-beam asynchronous precision laser cutting machine has a compact structure, and is respectively provided with laser cutting heads corresponding to the cross beams, which can synchronously complete the cutting of the same pattern, and can also complete the cutting of different patterns separately, and can also complete large-format cutting through splicing and cooperation between the cross beams, thereby improving the working efficiency and processing range of the cutting machine and realizing online unmanned processing; in addition, multiple cross beam anti-collision safety measures improve the safety of use.

### BRIEF DESCRIPTION OF THE FIGURES

In order to more clearly illustrate the technical solutions in the embodiments disclosed herein, the drawings are briefly introduced below. Obviously, the drawings described below are only some embodiments disclosed herein. For ordinary technicians in this field, other drawings can be obtained based on these drawings without creative work.

FIG. 1 shows a schematic diagram of the structure of a multi-beam asynchronous precision laser cutting machine in a specific embodiment.

FIG. 2 shows a schematic diagram of the structure of the beam in a specific embodiment.

FIG. 3 shows a schematic diagram of the installation of the accordion protective cover in a specific embodiment.

### DESCRIPTION

The following description of the technical scheme in the disclosed embodiment is provided in conjunction with the drawings herein. Obviously, the described embodiment is only one embodiment, and not all of the embodiments. Based on the embodiment in this disclosure, all other embodiments obtained by ordinary technicians in this field without creative work are within the scope of protection of this disclosure. In this description, it should be noted that the terms “center”, “upper”, “lower”, “left”, “right”, “vertical”, “horizontal”, “inside”, “outside” and the like indicate the orientation or position relationship based on the orientation or position relationship shown in the drawings, which is only for the convenience of the description and for simplifying the description, and does not indicate or imply that the device or element referred to must have a specific orientation, be constructed and operated in a specific orientation, and therefore cannot be understood as a limitation. In addition, the terms “first”, “second”, and “third” are used for descriptive purposes only and cannot be understood as indicating or implying relative importance.

In the present description, it should be noted that, unless otherwise clearly specified and limited, the terms “installation”, “connection”, and “connection” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal connection of two components.

For ordinary technicians in this field, the specific meanings of the above terms in the present description can be understood according to specific circumstances.

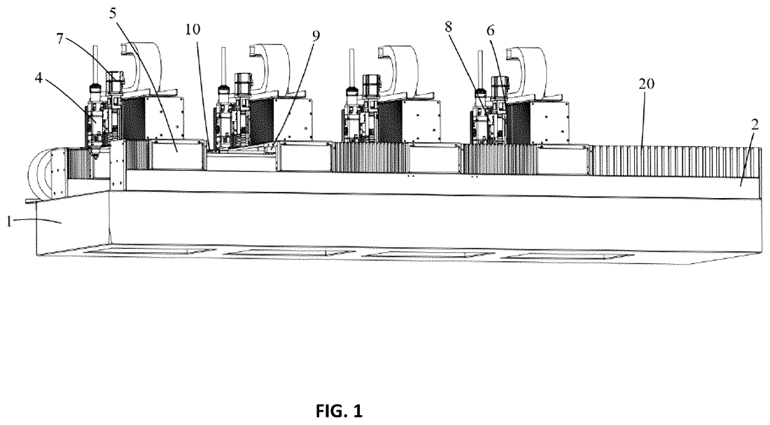

Referring to FIGS. 1 to 3, a multi-beam asynchronous precision laser cutting machine includes a horizontally arranged lathe bed 1, longitudinal beams 2 arranged on both sides of the top of the bed 1, and four gantry cutting mechanisms sliding on the longitudinal beams 2. The gantry cutting mechanism includes a transverse beam 3 perpendicular to the longitudinal beam 2, a lifting mechanism slidingly arranged on the transverse beam 3, and a laser cutting head 4 connected to the lifting mechanism. The tops of the two longitudinal beams 2 are respectively provided with first guide rails (not shown) along their length directions, and the top of one longitudinal beam 2 is provided with a first linear motor (not shown) parallel to the first guide rail. The bottoms of both ends of the transverse beam 3 are respectively provided with connecting seats 5, and the connecting seats 5 are connected to the first guide rail.

The slider and the moving subassembly of the first linear motor, the side of the crossbeam 3 is provided with a second guide rail along its length direction, the top of the crossbeam 3 is provided with a second linear motor, the lifting mechanism is connected to the slider of the second guide rail and the moving subassembly of the second linear motor through the first slide 6, the lifting mechanism includes a servo motor 7 fixed to the top of the first slide 6 and a second slide 8 connected to the servo motor 7, and the laser cutting head 4 is fixed to the second slide 8.

In this technical solution, the bed and the crossbeam are also provided with a tank chain for gathering the wiring harness, etc. The four gantry cutting mechanisms are sequentially slidably arranged on the longitudinal beam, which can meet the large-format 450 mm*2500 mm. The processing requirements of the two first rails are arranged in parallel, and the first linear motor is also parallel to the two first rails. During installation, the laser interferometer is used to measure the accuracy, and the installation accuracy between the two first rails and between the first rail and the first linear motor is improved, thereby improving the movement accuracy of the gantry cutting mechanism, that is, improving the processing accuracy of the laser cutting head. The second rail and the second linear motor are installed in the same way. Each of the first rail, the second rail, the first linear motor, and the second linear motor uses conventional structures. Each beam corresponds to an independently arranged first linear motor, which can synchronously complete the cutting of the same pattern, or separately complete the cutting of different patterns. It can also complete large-scale cutting through splicing and cooperation between beams, improving the cutting machine. The working efficiency and processing range of the aluminum foil are improved. The aluminum foil is fed by a method such as a roll-to-roll method, and online unmanned processing is realized. The servo motor is connected to the lead screw through a coupling, etc., and the second slide is connected to the screw nut of the lead screw on the side away from the laser cutting head. The laser cutting head is driven to rise and fall by the forward and reverse rotation of the servo motor. A third guide rail is provided between the second slide and the first slide to improve the stability and accuracy of the lifting of the laser cutting head. The multi-beam asynchronous precision laser cutting machine has a compact structure and is provided with laser cutting heads corresponding to the beams. It can synchronously complete the cutting of the same graphics, and can also complete the cutting of different patterns separately. It can also complete large-format cutting through splicing and cooperation between beams, improve the working efficiency and processing range of the cutting machine, and realize online unmanned processing. For example, as shown in FIG. 1, the bed 1 is formed of granite in one piece, and its top surface is provided with avoidance grooves corresponding to the laser cutting head 4, and the thickness of the bed 1 is greater than 250 mm.

In this technical solution, the structure of granite is dense and uniform, with high strength, good rigidity and extremely small expansion coefficient. In addition, it has the advantages of not easy to deform, not easy to magnetize, and completely free of internal stress. Four through grooves are set on the top surface of the bed as avoidance grooves to avoid damage to the bed during processing. At the same time, the processed waste falls into the avoidance groove to avoid interference with the subsequent processing of aluminum foil.

The overall rigidity of the bed, the thickness of the bed is greater than 250 mm; the longitudinal beam is fixed to the top surface of the bed by bolts, etc.

Both sides are used to install the corresponding first guide rail and the first linear motor.

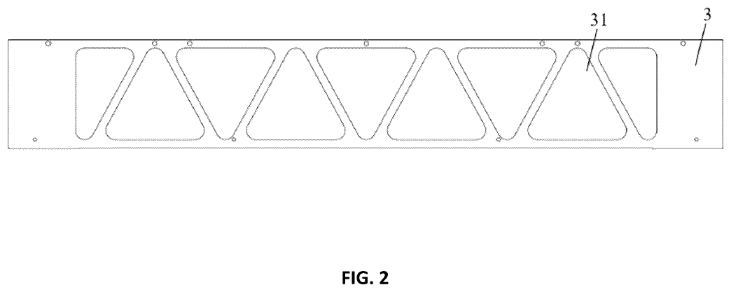

For example, as shown in FIGS. 1 to 3, the crossbeam 3 is formed of an aluminum alloy in one piece, and a number of weight-reducing holes 31 are arranged inside it (see FIG. 2).

In this technical solution, the crossbeam is made of seven-series aluminum alloys such as 7075, and the lightweight design of the weight-reducing holes is set to reduce its own weight while ensuring its strength, thereby improving the dynamic performance of the movement of the crossbeam.

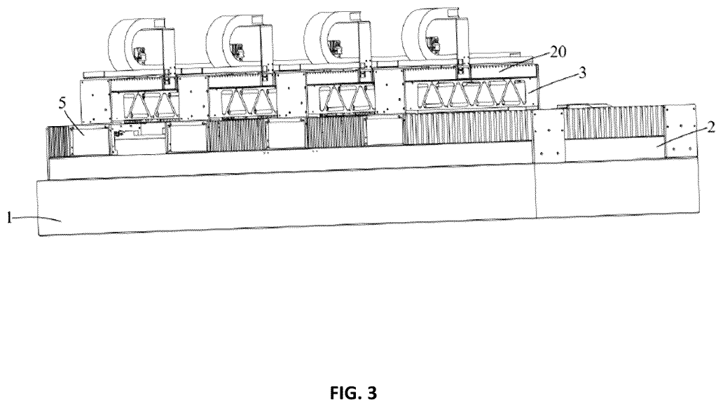

For example, as shown in FIGS. 2 and 3, the cross section of the weight-reducing hole 31 is a triangle.

In this technical solution, the triangle is stable, firm, and pressure-resistant. After the weight-reducing holes are processed, the crossbeam still has sufficient strength. The side of the crossbeam close to the laser cutting head is connected with a mounting plate for installing the second guide rail, etc. The mounting plate blocks the corresponding end of the weight-reducing hole to prevent dust from entering the second guide rail and the second linear motor through the weight-reducing hole.

Exemplarily, the first linear motor and the second linear motor are both bilateral linear motors.

In this technical solution, the first linear motor and the second linear motor use bilateral linear motors, which have the advantages of high efficiency, high precision, high dynamic response, etc., to achieve efficient, accurate and fast motion control of the cutting machine as a whole, and improve the precision and efficiency of processing. Among them, the moving subassembly of the second linear motor is arranged close to the side where the laser cutting head is located, and is connected to the first slide seat, driving the lifting mechanism and the laser cutting head to move back and forth along the length direction of the beam.

Exemplarily, as shown in FIG. 1, an anti-collision device is arranged between adjacent beams 3. In this technical solution, the anti-collision device can avoid collision between adjacent beams, protect the laser cutting head, etc., and extend the service life.

Exemplarily, as shown in FIG. 1, the anti-collision device includes a limit sensor 9, a buffer device 10 and a grating ruler (not shown) for monitoring and measuring position. In this technical solution, the limit sensor uses a proximity sensor, the buffer device is a mechanical buffer limit, a hydraulic buffer is used, and the grating ruler uses an absolute grating ruler. Among them, the principles of the proximity sensor and the absolute grating ruler are not described here one by one. Multiple anti-collision safety measures improve the safety of use. For example, as shown in FIGS. 1 and 3, the longitudinal beam 2 and the cross beam 3 are respectively provided with an accordion protective cover 20.

The ends of the crossbeam and the longitudinal beam are respectively provided with sealing plates. The corresponding ends of the accordion protective cover are fixed to the corresponding sealing plates. Among them, the accordion protective cover on the longitudinal beam adopts a gate-shaped accordion protective cover. The end close to the gantry cutting mechanism is fixed to the connecting seat of the crossbeam through its own end plate. The structure of the connecting seat is also a gate-shaped structure, including a top plate and two side plates. Among them, the top surface of the top plate is fixed to the slider corresponding to the first guide rail and the mover assembly of the first linear motor. The side plate cooperates with the accordion protective cover to isolate the slider of the first guide rail and the first linear motor from the outside world to prevent dust from entering and ensure its running accuracy. The outer side of the side plate is provided with a groove, which is convenient for connecting to the accordion protective cover through bolts; the seven-shaped accordion protective cover on the crossbeam can isolate the side and top surfaces of the crossbeam, and cooperate with the mounting plate that blocks the weight reduction hole to isolate the second guide rail and the second linear guide from the outside world.

In summary, the multi-beam asynchronous precision laser cutting machine has a compact structure and is equipped with laser cutting heads corresponding to the beams. It can complete the cutting of the same pattern synchronously, or complete the cutting of different patterns separately. It can also complete large-format cutting through splicing and cooperation between beams, improve the working efficiency and processing range of the cutting machine, and realize online unmanned processing; in addition, multiple beams have anti-collision safety measures to improve the safety of use.

It should be noted that in this article, the terms “include”, “comprise” or any other variant thereof are intended to cover non-exclusive inclusion, so that the process, method, article or equipment including a series of elements includes not only those elements, but also other elements not explicitly listed, or also includes elements inherent to such process, method, article or equipment. In the absence of more restrictions, the elements defined by the sentence “including a” do not exclude the existence of other identical elements in the process, method, article or equipment including the elements.

What is claimed is:

1. A multi-beam asynchronous precision laser cutting machine, comprising:
a horizontally arranged bed;
longitudinal beams arranged on both sides of a top of the horizontally arranged bed; and
a plurality of gantry cutting mechanisms sliding on the longitudinal beams, each of the plurality of gantry cutting mechanisms includes a transverse beam perpendicular to a longitudinal beam, a lifting mechanism slidingly arranged on the transverse beam and a laser cutting head connected to the lifting mechanism, wherein tops of the longitudinal beams are respectively provided with first guide rails along their length directions, a top of one longitudinal beam is provided with a first linear motor parallel to a first guide rail, bottoms of both ends of the beam are respectively provided with connecting seats, the connecting seats are connected to a slider of the first guide rail and a moving subassembly of the first linear motor, a side of the beam is provided with a second guide rail along its length direction, the top of the beam is provided with a second linear motor, the lifting mechanism is connected to the slider of the second guide rail and the moving subassembly of the second linear motor through the first slide, the lifting mechanism includes a servo motor fixed to the top of the first slide and a second slide drivingly connected to the servo motor, and the laser cutting head is fixed to the second slide.

2. The multi-beam asynchronous precision laser cutting machine of claim 1, wherein the bed is integrally formed of granite, and its top surface is provided with avoidance grooves corresponding to the laser cutting head, and a thickness of the bed is greater than 250 mm.

3. The multi-beam asynchronous precision laser cutting machine of claim 1, wherein the beam is integrally formed of aluminum alloy, and a plurality of weight-reducing holes are provided inside.

4. The multi-beam asynchronous precision laser cutting machine of claim 3, wherein a cross-section of the weight-reducing hole is triangular.

5. The multi-beam asynchronous precision laser cutting machine of claim 1, wherein the first linear motor and the second linear motor are both bilateral linear motors.

6. The multi-beam asynchronous precision laser cutting machine of claim 1, wherein an anti-collision device is provided between adjacent beams.

7. The multi-beam asynchronous precision laser cutting machine of claim 6, wherein the anti-collision device includes a limit sensor, a buffer device and a grating ruler for monitoring and measuring position.

8. The multi-beam asynchronous precision laser cutting machine of claim 1, wherein the longitudinal beams and cross beams are respectively provided with accordion protective covers.
